(19) United States
(12) Patent Application Publication
(10) Pub. No.: US 2020/0346467 A1
(43) Pub. Date: Nov. 5, 2020

(54) FLUID RESERVOIRS

(71) Applicant: HEWLETT-PACKARD DEVELOPMENT COMPANY, L.P., Spring, TX (US)

(72) Inventors: Daryl E. ANDERSON, Corvallis, OR (US); Steven T. CASTLE, Corvallis, OR (US); Andrew KOLL, Corvallis, OR (US)

(73) Assignee: HEWLETT-PACKARD DEVELOPMENT COMPANY, L.P., Spring, TX (US)

(21) Appl. No.: 16/763,060

(22) PCT Filed: Dec. 11, 2017
(86) PCT No.: PCT/US2017/065515

§ 371 Date: May 11, 2020

(51) Int. Cl. B41J 2/175; B41J 2/195

(52) U.S. Cl. CPC B41J 2/17566; B41J 2002/17579; B41J 2/195; B41J 2/17503

(57) ABSTRACT

A fluid reservoir may include a fluid chamber to contain a fluid, and an impedance sensor exposed to a fluid within the fluid chamber. The impedance sensor senses an impedance at the impedance sensor, determines a particle vehicle separation level of the fluid within the fluid chamber based on the sensed impedance, and sends an activation signal to a moveable carriage to which the fluid reservoir is coupled to stir the fluid within the fluid reservoir based on the sensed impedance.

### BACKGROUND

Fluid dispensing systems include any device that can eject a fluid onto a substrate. Example fluid dispensing systems may include print cartridges, lab-on-chip devices, fluid dispensing cassettes, page-wide arrays implemented in printing devices, among others. Each of these examples may include a fluid reservoir fluidically coupled to, for example, a fluidic die where the fluidic die ejects the fluid and/or moves the fluid within the fluidic die. A fluidic die may be used to move fluids within the fluidic die, eject fluids onto a substrate such as print media, or combinations thereof. The fluids within a fluidic die may include any fluid that may be moved within or ejected from the fluidic die. For example, the fluids may include inks, dyes, chemical pharmaceuticals, biological fluids, gases, and other fluids. The fluids may be used to print images on media or effectuate chemical reactions between different fluids, for example. Further, in additive manufacturing processes such as those that use a three-dimensional (3D) printing device, the fluidic die may eject build materials, adhesives, and other fluids that may be used to build a 3D object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a fluid reservoir, according to an example of the principles described herein.

FIG. 2 is a block diagram of a fluid dispensing system, according to an example of the principles described herein.

FIG. 3 is a block diagram of a fluid dispensing system, according to another example of the principles described herein.

FIG. 4 is a block diagram of a fluid dispensing system, according to yet another example of the principles described herein.

FIG. 5 is a flowchart depicting a method of correcting particle vehicle separation within a fluid, according to an example of the principles described herein.

FIG. 6 is a flowchart depicting a method of correcting particle vehicle separation within a fluid, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Some fluids moved within and/or ejected from a fluidic die may include a fluid vehicle and particles where the fluid vehicle is used to carry or suspend a particle within the fluid vehicle. These types of fluids may include, for example, a printing fluid that includes color pigments suspended in an ink vehicle. Printing systems such as inkjet printers include printheads, and the printheads include firing chambers including nozzle regions having printing fluid therein, and fluid ejectors to eject the printing fluid in the nozzle regions onto media. Over time, the color pigments in the ink vehicle located in the nozzle region may diffuse and move away from a homogenous fluid resulting in pigment ink vehicle separation. The separation of the pigment particles from the ink vehicle may be referred to herein as pigment ink vehicle separation or pigment vehicle separation (PIVS), or may be generically referred to herein as particle vehicle separation (PVS).

PVS may occur when a particle-containing fluid sits in a portion of the fluidic die or a reservoir coupled thereto for a period of, for example, seconds or minutes without being refreshed, circulated, or mixed. Due to evaporation, settling, and other effects related to the fluid formulation, particles within the fluid may, over time, migrate out of a first portion of the fluid reservoir, and collect in other portions of the fluidic reservoir such as at a bottom of the fluid reservoir. When PVS occurs, this leaves an amount of the fluid in the fluid reservoir without its particle constituent. If, in the case of a pigmented ink, the pigmented ink is then sent to a fluidic die for ejection from a nozzle or for movement within the fluidic die in such a PVS condition, the fluid may contain a greater amount of particles than of the fluid vehicle. This, in turn, may cause the PVS fluid to not perform as intended such as clogging passageways, chambers and fluid ejection nozzles of the fluidic die. The first volumes of fluid out of the fluid reservoir will not have a correct amount or concentration of pigment particles or colorant in it, and may affect the functioning of the fluidic die and a print quality of a part of a printed image if the fluid is ejected from the fluidic die.

Additionally, at times, pigment ink vehicle separation may result in solidification of the printing fluid in the nozzle region. Particle interaction in a PVS scenario may cause a spectrum of responses based on characteristics of the particles and the environment in which the fluid exists, including, for example, the geometry of the particles and the design of the chambers within the fluidic die, among other characteristics. In this case, the respective nozzle region may prevent the ejection of printing fluid and reduce the lifespan of a corresponding fluid ejector.

Even though pigment inks are used herein as an example to describe a fluid vehicle and particles where the fluid vehicle is used to carry or suspend a particle within the fluid vehicle, similar fluids including particles and a fluid vehicle may be equally applicable. For example, some biological fluids such as blood may include particles suspended in a fluid vehicle. In the case of blood, blood includes bloods cells suspended in blood plasma. In this example, the blood cells may separate or diffuse where a higher concentration of blood cells exist in a first portion of the blood plasma relative to another portion of the blood plasma where there may exist a relatively lower concentration of blood cells.

Therefore, PVS may occur in a wide range of fluids that are moved within and/or ejected from a fluidic die. Detection of the separation of a particle from its fluid vehicle may allow for remedial measures to be taken to correct any particle concentration disparities within the fluid. One such remedial measure may be to measure the level of PVS in a fluid reservoir, and stir the fluid within the fluid reservoir in order to bring the fluid from a PVS state to a homogeneous state.

Examples described herein provide a fluid reservoir. The fluid reservoir may include a fluid chamber to contain a fluid, and at least one impedance sensor exposed to a fluid within the fluid chamber. The impedance sensor senses an impedance at the impedance sensor, determines a particle vehicle separation level of the fluid within the fluid chamber based on the sensed impedance, and sends an activation signal to a moveable carriage to which the fluid reservoir is coupled to stir the fluid within the fluid reservoir based on the sensed impedance.

The activation signal may be sent in response to a determination that the sensed impedance indicates particle vehicle separation above a threshold. The activation signal is not sent in response to a determination that the sensed impedance indicates particle vehicle separation below the threshold. The particle vehicle separation level of the fluid may be defined by an impedance value based on the sensed impedance. A relatively lower impedance may correspond to a higher particle concentration within the fluid, and a relatively higher impedance corresponds to a lower particle concentration within the fluid.

The fluid reservoir may include a sensing die extending through a level of fluid in the reservoir, and a first impedance sensor and a second impedance sensor coupled to the sensing die at different portions of the sensing die to sense a degree of pigment separation in the fluid at different levels of the fluid. Further, the fluid reservoir may include a controller to determine a sensed impedance at the first impedance sensor, determine a sensed impedance at the second impedance sensor, determine a particle vehicle separation level of a fluid within the fluid chamber based on the sensed impedance at the first impedance sensor and the sensed impedance at the second impedance sensor, and send the activation signal to the moveable carriage to stir the fluid within the fluid chamber based on the particle vehicle separation level of the fluid.

The fluid reservoir may also include a third impedance sensor placed intermittent between the first impedance sensor and the second impedance sensor. When any of the first, second, and third impedance sensors are not in contact with the fluid, a maximum impedance is sensed and disregarded. A fluid level sensor may be included in the fluid reservoir to provide a sensed level of fluid within the fluid reservoir.

Examples described herein also provide a fluid dispensing system. The fluid dispensing system may include a moveable carriage to convey a fluid reservoir, and a controller to activate the moveable carriage to move the fluid reservoir in a coordinate direction based on an impedance-sensed particle vehicle separation level of a fluid within the fluid reservoir. The fluid dispensing system may include a sensing die extending through a level of fluid in the reservoir, and a first electrode and a second electrode coupled to the sensing die at different portions of the sensing die to sense the particle vehicle separation level in the fluid at different levels of the fluid. The controller determines a sensed impedance at the first electrode, determines a sensed impedance at the second electrode, determines the particle vehicle separation level of the fluid within the fluid reservoir based on the sensed impedance at the first electrode and a sensed impedance at the second electrode, and sends an activation signal to the moveable carriage to stir the fluid within the fluid reservoir based on the particle vehicle separation level of the fluid.

The impedance sensed at the first and second electrodes is corresponds to or is proportional to a dispersion level of a solid within a fluid vehicle of the fluid. The controller activates the carriage in response to a determination that the sensed impedance indicates a particle vehicle separation above a threshold. The particle vehicle separation level of the fluid is defined by an impedance value based on the sensed impedance. A relatively lower impedance corresponds to a higher particle concentration within the fluid, and a relatively higher impedance corresponds to a lower particle concentration within the fluid.

The fluid dispensing system may include a third electrode placed intermittent between the first electrode and the second electrode. When any of the first, second, and third electrodes are not in contact with the fluid, a maximum impedance is sensed and disregarded. The first electrode, the second electrode, or combinations thereof measure a level of the fluid within the fluid reservoir.

Examples described herein also provide a method of correcting particle vehicle separation within a fluid. The method may include receiving a first sensed impedance value of the fluid from a first impedance sensor located at a first level within a fluid reservoir, and receiving a second sensed impedance value of the fluid from a second impedance sensor located at a second level within the fluid reservoir. The method may also include determining a particle vehicle separation level of the fluid based on the first sensed impedance at the first impedance sensor and the sensed impedance at the second impedance sensor, and sending an activation signal to a moveable carriage to which the fluid reservoir is coupled to move the fluid reservoir in a coordinate direction to stir the fluid within the fluid reservoir based on the particle vehicle separation level of the fluid.

The method may include receiving a third sensed impedance value of the fluid from a third impedance sensor, and determining a particle vehicle separation level of the fluid based on the first sensed impedance at the first impedance sensor, the sensed impedance at the second impedance sensor, and the third sensed impedance at the third impedance sensor. The gradient of particle vehicle separation within the fluid is compared to gradient values maintained in a look-up table to determine the pigment separation between any of the first, second, and third impedance sensors.

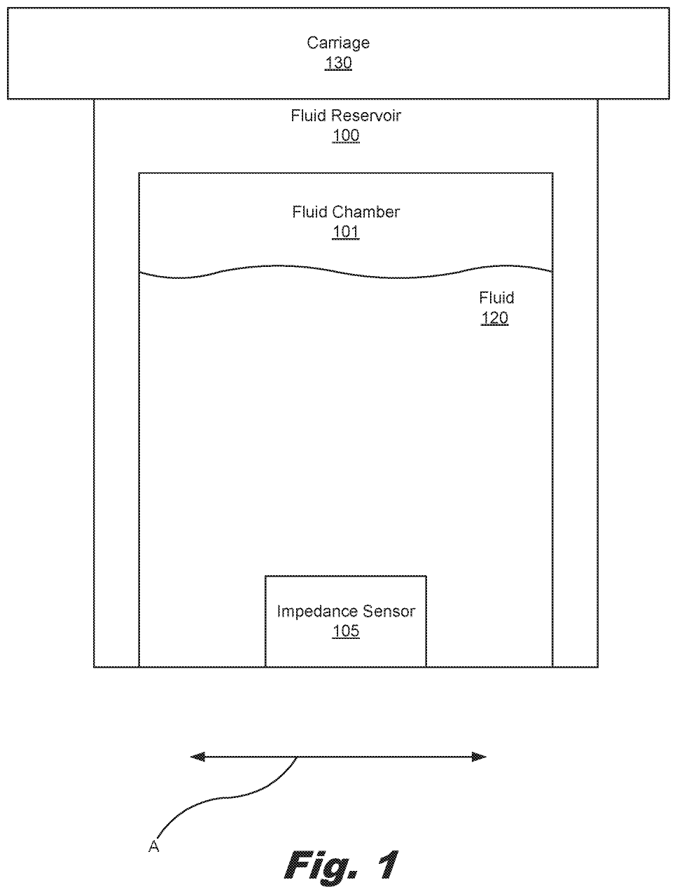

Turning now to the figures, FIG. 1 is a block diagram of a fluid reservoir (100), according to an example of the principles described herein. The fluid reservoir (100) may include a fluid chamber (101) to contain a fluid (120). The fluid reservoir (100) may be a stand-alone fluid containment device, or may be fluidically and/or mechanically coupled to another device or system. For example, the fluid reservoir (100) may be fluidically and mechanically coupled to a fluid dispensing device such as a printhead or a fluid ejection die to serve as a source for fluid that the printhead or fluid ejection die dispense. The fluid (120) within the fluid reservoir (100) may be any fluid containing a particle suspended within a fluid vehicle.

The fluid reservoir (100) may include at least one impedance sensor (105) exposed to the fluid (120) within the fluid chamber (101) of the fluid reservoir (100). The at least one impedance sensor (105) senses an impedance of the fluid (120) at the location of the impedance sensor (105), and determines a particle vehicle separation (PVS) level of the fluid within the fluid chamber (101) of the fluid reservoir (100) based on the sensed impedance. The impedance sensor (105) may also send an activation signal to a moveable carriage (130) to which the fluid reservoir (100) is coupled to stir the fluid (120) within the fluid reservoir (100) based on the sensed impedance.

The at least one impedance sensor (105) may be any device that can sense an impedance value of the fluid (120). In one example, the impedance sensor (105) may be an electrode electrically coupled to a voltage or current source. The electrode may be a thin-film electrode formed on an interior surface of the fluid chamber (101) within the fluid reservoir (100). In one example, a current may be applied to the electrode when a fluid particle concentration is to be detected, and a voltage may be measured. In another example, a voltage may be applied to the electrode when a fluid particle concentration is to be detected, and a current may be measured.

In the example where a fixed current is applied to the fluid (120) surrounding the at least one impedance sensor (105), a resulting voltage may be sensed. The sensed voltage may be used to determine an impedance of the fluid (120) surrounding the at least one impedance sensor (105) at that area within the fluid reservoir (100) at which the at least one impedance sensor (105) is located. Electrical impedance is a measure of the opposition that the circuit formed from the at least one impedance sensor (105) and the fluid (120) presents to a current when a voltage is applied to the impedance sensor (105), and may be represented as follows:

$$Z = \frac{V}{I} \qquad Eq . 1$$

where Z is the impedance in ohms (Q), V is the voltage applied to the impedance sensor (105), and I is the current applied to the fluid (120) surrounding the impedance sensor (105). In another example, the impedance may be complex in nature, such that there may be a capacitive element to the impedance where the fluid (120) may act partially like a capacitor. For complex impedances, the current applied to the impedance sensor (105) may be applied for a particular period of time, and a resulting voltage may be measure at the end of that time. A measured capacitance in this example may change with the properties of the fluid (120): one such property of the fluid (120) being particle concentration.

The detected impedance (Z) is proportional or corresponds to a particle concentration in the fluid (120). Stated in another way, the impedance (Z) is proportional or corresponds to a dispersion level of the particles within the fluid vehicle of the fluid (120). In one example, if the impedance is relatively lower, this may indicate that a higher particle concentration exists within the fluid (120) in that area at which the particle concentration is detected. Conversely, if the impedance is relatively higher, this indicates that a lower particle concentration exists within the fluid in that area at which the particle concentration is detected. Lower particle concentration within a portion of the fluid (120) may indicate that PVS has occurred, and that remedial measures may be taken to ensure that the particle concentration is made homogeneous throughout all the fluid within the fluid reservoir (100). Homogeneity may include homogeneity based on empirical homogeneity data, homogeneity based on an original or manufactured homogeneity of the fluid (120), a threshold level of homogeneity, or combinations thereof.

In one example, when the impedance value reaches a maximum value or within a threshold of the maximum value, this may indicate that the at least one impedance sensor (105) is actually not in contact with the fluid (120). In this case, the impedance value detected by the at least one impedance sensor (105) may be disregarded in determining whether a remedial process such as the stirring of the fluid reservoir (100) by activation of the carriage (130) should be conducted to render the fluid (120) homogenous again. Further, by receiving input from an impedance sensor (315-1 315-2) that any one of the impedance sensors (315-1 315-2) is not exposed to the fluid (120) based on a detected maximum value, those impedance values may be disregarded in determining a PVS value of the fluid (120).

An acceptable homogeneity of the fluid (120) with regards to the particle concentration may be based on an original or manufactured homogeneity value. The output impedance values from the at least one impedance sensor (105) may be evaluated by, for example, a processing device communicatively coupled to the at least one impedance sensor (105). The processing device may execute an evaluation module that evaluates the detected impedance values against the original or manufactured homogeneity values. These original or manufactured homogeneity values, in one example, may be provided in a look-up table (LUT) that provides a level of homogeneity based on any detected impedance value from the at least one impedance sensor (105).

In the example, shown in FIG. 1, the at least one impedance sensor (105) may include a plurality of impedance sensors (105) with a first impedance sensor detecting or sensing a different impedance value than that detected or sensed by a second impedance sensor. In one example, different impedance values sensed amongst the plurality of impedance sensors (105) may indicate a lack of homogeneity in particle concentration with the fluid (120) maintained in the fluid chamber (101) of the fluid reservoir (100). Thus, in one example, a comparison between impedance values sensed among each of the impedance sensors (105) may be used to determine whether a remedial process should be conducted to correct the PVS of the fluid (120). In one example including a plurality of impedance sensors (105), each impedance value detected by each of the impedance sensors (105) may be evaluated against those values in the LUT, and remedial processes may be started based on whether a detected PVS value of the fluid (120) is within a threshold particle concentration as indicated by the values in the LUT.

In another example, an acceptable homogeneity of the fluid (120) with regards to the particle concentration may be based on empirical homogeneity data. In this example, the empirical homogeneity data may be obtained through testing a PVS value of the fluid (120) over a period of time. The empirical homogeneity data may be stored in the LUT as impedance values over time are detected and recorded in the LUT. The LUT may be referred to in order to compare a current PVS values as detected by the impedance sensors (105) with the empirical homogeneity data.

The remedial processes used to correct a PVS state of the fluid (102) and cause the fluid (120) to be homogeneous may include any process and using any device that renders the fluid (120) homogeneous again as to the concentration of particles therein. In one example, the remedial process may include stirring the fluid (120) within the fluid chamber (101). In one example, the fluid reservoir (100) may be movably coupled to a carriage (130). In this example, the carriage (130) may be a device that moves the fluid reservoir (100) from one position to another with in a printing system where the fluid reservoir is fluidically coupled to a fluid ejection die such as those fluid ejection dies found in a printhead. In this example, the fluid reservoir (100) may be a scanning cartridge in a printing device. However, in another example, the fluid reservoir (100) may be movably coupled to the carriage (130) without being mechanically or fluidically coupled to another device. The carriage (130) may move the fluid reservoir (100) in, for example, the directions indicated by arrow A. By moving the fluid reservoir (100) in the directions indicated by arrow A, the fluid (120) within the fluid chamber (101) may be stirred as the fluid moves within the fluid chamber (101) as a result of the movement of the fluid reservoir (100) relative to the carriage (130).

In one example, the carriage (130) may violently shake the fluid reservoir (100) sufficient to create a movement of the fluid (120) within the fluid chamber (101). In this example, the shaking of the fluid reservoir (100) may occur with any intensity, duration, and number of shaking iterations. For example, an initial PVS value may be detected using the impedance sensors (105). The carriage (130) may violently shake the fluid reservoir (100) for a number of seconds, and the impedance sensors (105) may make a subsequent PVS value detection using the impedance sensors (105). The subsequent PVS value may be compared to empirical homogeneity data in the LUT, may be compared to original or manufactured homogeneity data stored in the LUT, may be compared to the initial PVS value detected, or combinations thereof. Further, the initial and any subsequent PVS values detected by the impedance sensors (105) may be compared to a threshold based on the empirical homogeneity data, the original or manufactured homogeneity data, or combinations thereof.

If the detected PVS value after the initial or subsequent PVS detection instances is not homogenous based on empirical homogeneity data, the original or manufactured homogeneity of the fluid (120), or combinations thereof, or within a threshold of these homogeneity basis, then the carriage (130) may violently shake the fluid reservoir (100) again in order to stir the fluid (120) again and bring the fluid (120) closer to homogeneity. Thus, the process of detecting a PVS value of the fluid (120) and shaking the fluid reservoir (100) may be performed any number of times until the fluid (120) is brought into a homogenous state.

In one example, the carriage (130) may move the fluid reservoir (100) in the directions indicated by arrow A a number of times such as, for example, 20 times back and forth, per iteration of the remedial process until the difference between the measured PVS level and an expected or actual PVS value is within a certain delta or is identical to the expect or actual PVS value.

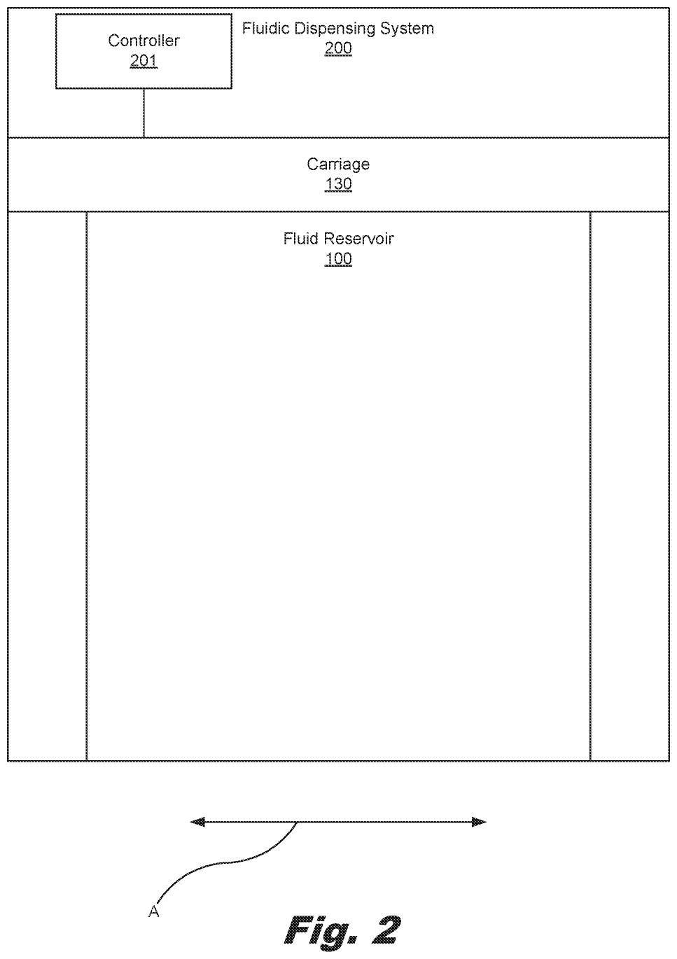

FIG. 2 is a block diagram of a fluid dispensing system (200), according to an example of the principles described herein. The fluid dispensing system may include a moveable carriage (130) to convey a fluid reservoir (100), and a controller (201) to activate the moveable carriage (130) to move the fluid reservoir (100) in at least one coordinate direction based on an impedance-sensed particle vehicle separation level of a fluid within the fluid reservoir (100). In this example, the fluid reservoir (100) may include the elements described herein in connection with FIG. 1. The impedance sensor (105) of FIG. 1 may be include within the fluid reservoir (100) of FIG. 2, and may provide a PVS value to the controller (201). The controller (201) may then instruct the carriage (130) to move the fluid reservoir (100) in the directions indicated by arrow A in order to stir the fluid (120) within the fluid reservoir (100) as described herein in connection with FIG. 1.

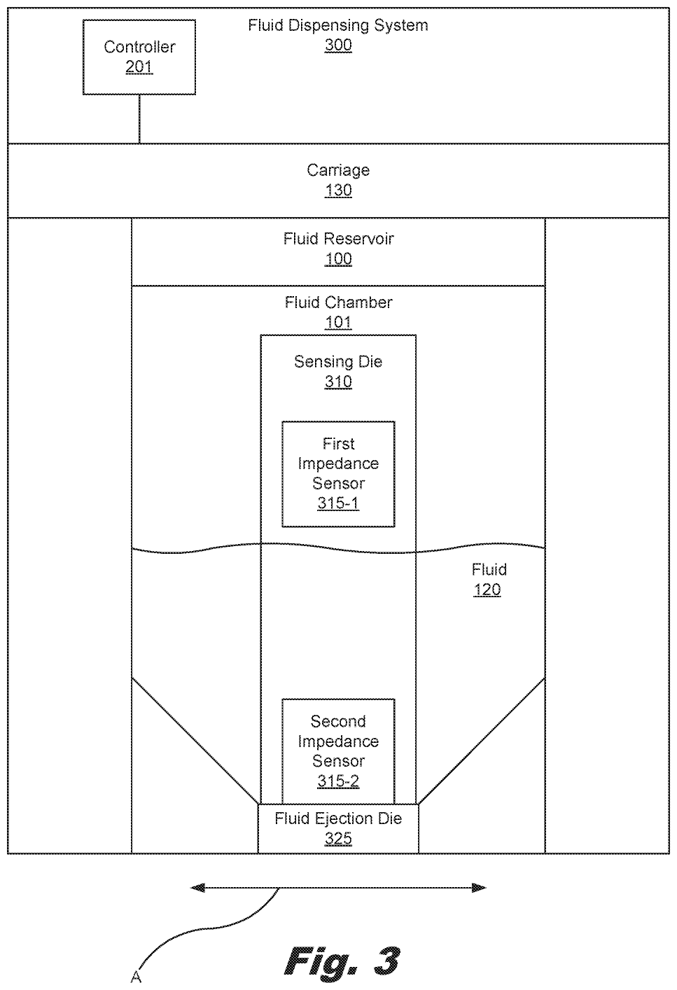

FIG. 3 is a block diagram of a fluid dispensing system (300), according to another example of the principles described herein. The fluid dispensing device (300) of FIG. 3 includes elements similar to those described herein in connection with FIGS. 1 and 2. The example of FIG. 3 may include a sensing die (310) included within the fluid chamber (101) of the fluid reservoir (100). The sensing die (310) may be any substrate on which functional elements such as at least one impedance sensor (105) may be formed. In one example, the sensing die (310) may be made of any number of layers of silicon and may facilitate an electrical coupling of, for example, a first impedance sensor (315-1) and second impedance sensor (315-2) with other electrical components associated with the fluid reservoir (100) as described herein.

The first impedance sensor (315-1) and the second impedance sensor (315-2) may be any device that can sense an impedance value of the fluid (120) and may function identically to the impedance sensor (105) of FIG. 1. In one example, the first impedance sensor (315-1) and the second impedance sensor (315-2) may be an electrode electrically coupled to a voltage or current source. The electrode may be a thin-film electrode formed on an interior surface of the fluid chamber (101) of the fluid reservoir (100), and may be formed on the sensing die (310).

The sensing die (310) may extend along a height of the fluid chamber (101) such that the first impedance sensor (315-1) and the second impedance sensor (315-2) may be located at different levels of the sensing die (310) and corresponding levels of the fluid (120) within the fluid chamber (101). In the example of FIG. 3, the first impedance sensor (315-1) is not in contact with the fluid (120). In this example, the fluid (120) may have been depleted enough to expose the first impedance sensor (315-1) to air within the fluid chamber (101) and not the fluid (120) itself.

In contrast, the second impedance sensor (315-2) in the example of FIG. 3 is located at the bottom of the sensing die (310), and is exposed to the fluid (120). In this situation, the first impedance sensor (315-1) may detect a maximum impedance value since the first impedance sensor (315-1) is not exposed to any of the fluid (120). In contrast, the second impedance sensor (315-2) as depicted in FIG. 3 is fully exposed to the fluid (120), and may detect a PVS value of the fluid (120) at that level of the fluid (120) within the fluid chamber (101).

In one example, the fluid reservoir (100) may include a fluid level sensor to detect the level of fluid (120) within the fluid reservoir (100). The fluid level sensor may be used in connection with the impedance values sensed by the first impedance sensor (315-1) and second impedance sensor (315-2) in order to determine which impedance values should and should not be considered. For example, the first impedance sensor (315-1), after an amount of the fluid (120) is delivered to a fluidically coupled fluid ejection die (325), may no longer be in physical contact with the fluid (120) in the fluid reservoir (100). As described herein, the first impedance sensor (315-1) may detect a maximum impedance value since it is not in contact with the fluid (120). Such an impedance sensed by the first impedance sensor (110) should not be used to determine the particle concentration of the fluid (120). By receiving input from the fluid level sensor that any one of the impedance sensors (315-1, 315-2, collectively referred to herein as 315) is not exposed to the fluid (120), those impedance values may be disregarded. In one example, the impedance sensors (315) themselves act as the fluid level sensor. However, in another example, the fluid level sensor may be a separate element electrically coupled to the sensing die (310) in addition to the impedance sensors (315) that detects the level of the fluid (120) within the fluid chamber (101).

In one example, each of the impedance values sensed by the impedance sensors (315) may be compared to determine which, if any of the impedance sensors (315) are defective. In this example, a sanity check may be initiated to determine if any of the sensed impedance values are not rational based on other sensed impedance values. By way of example, if five different impedance sensors (315) are included on the sensing die (310) with four of the five impedance sensors (315) along a vertical depth of fluid (120) indicating a monotonic trend moving down the sensing die (310), this may indicate PVS has occurred. If the fifth impedance sensor (315) placed between the four other impedance sensors (315) indicates a relatively higher or lower particle concentration beyond a threshold value, this may indicate an anomaly or defective impedance sensor (315) and the sensed impedance from the fifth impedance sensor (315) may be disregarded irrespective of the level of the fluid (120) within the fluid chamber (101). Alternatively, in another example, instead of disregarding the sensed impedance value of the fifth impedance sensor (315), the fifth impedance sensor (315) may reinitiate an impedance measurement to validate that an anomalous measurement was valid and repeatable. After a number of iterations of repeating anomalous measurements, the sensed impedance from the fifth impedance sensor (315) may then be disregarded.

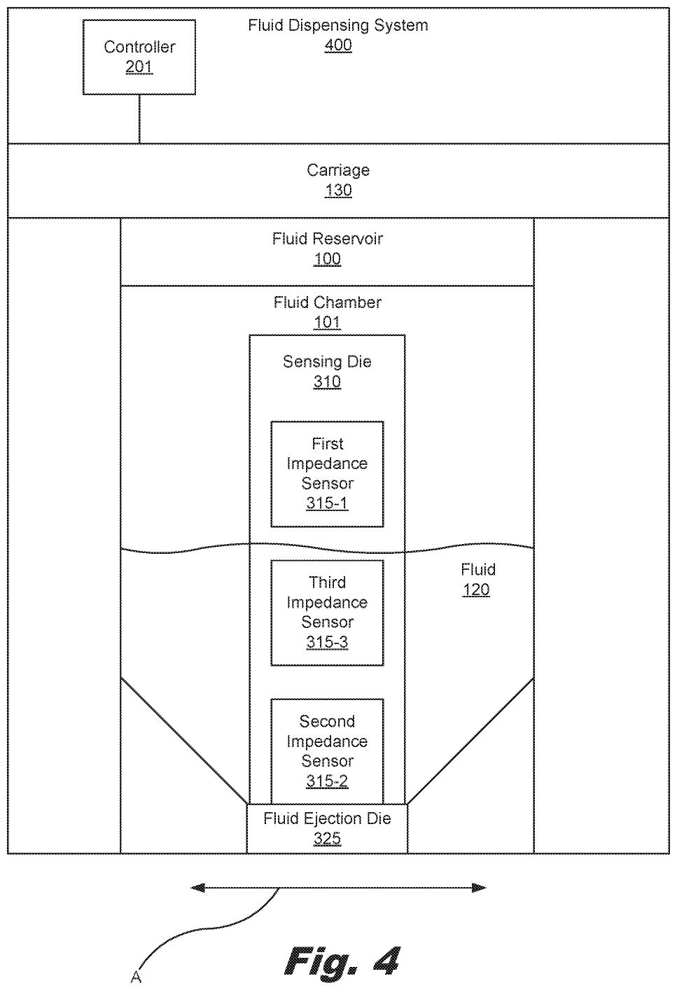

FIG. 4 is a block diagram of a fluid dispensing system (400), according to yet another example of the principles described herein. The fluid dispensing system (400) of FIG. 4 includes elements similar to those described herein in connection with FIGS. 1 through 3. The example of FIG. 4 may include a third impedance sensor (315-3) intermediate to the first and second impedance sensors (315-1, 315-2). The example of FIG. 4 is included to demonstrate that any number of impedance sensors (315) may be included on the sensing die (310), and these impedance sensors (315) may be used to detect PVS values at different levels of the fluid (120) within the fluid chamber (101), and may be used to detect a level of the fluid (120) within the fluid chamber (101) with a granularity and precision defined by the number of impedance sensors (315) included on the sensing die (310).

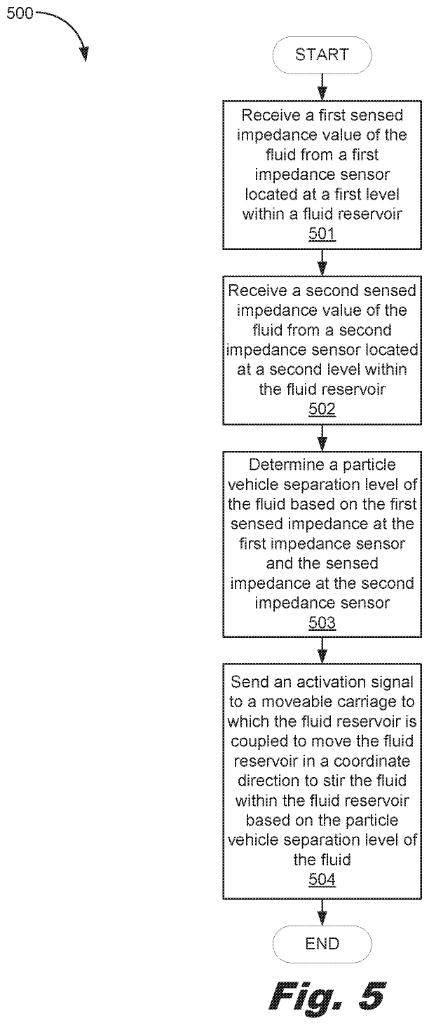

FIG. 5 is a flowchart depicting a method (500) of correcting particle vehicle separation within a fluid (120), according to an example of the principles described herein. The method may include receiving (block 501) a first sensed impedance value of the fluid (120) from the first impedance sensor (315-1) located at a first level within the fluid reservoir (100). The first impedance sensor (315-1) may be coupled to a first level of the sensing die (310). The method may also include receiving (block 502) a second sensed impedance value of the fluid from a second impedance sensor (315-2) located at a second level within the fluid reservoir (100). The second impedance sensor (315-2) may be coupled to a second level of the sensing die (310).

A particle vehicle separation (PVS) level of the fluid (120) may be determined (block 503) based on the first sensed impedance at the first impedance sensor (315-1) and the sensed impedance at the second impedance sensor (315-2). As the fluid (120) sits in the fluid reservoir (100), settling may occur with regard to the pigments within the fluid vehicle of the fluid (120), and PVS occurs. The PVS value detected by the first impedance sensor (315-1) may be higher than the PVS value detected by the second impedance sensor (315-2) since the pigments within the fluid (120) settle to the bottom, and the second impedance sensor (315-2) is located lower in the level of the fluid (120) than the first impedance sensor (315-1). In another example, the PVS values detected by the first and second impedance sensors (315-1, 315-2) may be compared to empirical homogeneity data, homogeneity based on an original or manufactured homogeneity of the fluid (120), a threshold level of homogeneity, or combinations thereof.

Although a first and second impedance sensors (315-1, 315-2) are described in connection with blocks 501 through 503, any number of impedance sensors (315) and their detected PVS values may be used to determine (block 503) the PVS level of the fluid (120). Further, the method may include sending (block 504) an activation signal to the moveable carriage (130) to which the fluid reservoir (100) is coupled to move the fluid reservoir (100) in a coordinate direction to stir the fluid (120) within the fluid reservoir (100) based on the particle vehicle separation level of the fluid (120).

As to FIG. 5, the method may further include receiving a third sensed impedance value of the fluid (120) from a third impedance sensor (315-3), and determining a particle vehicle separation level of the fluid based on the first sensed impedance at the first impedance sensor, the sensed impedance at the second impedance sensor, and the third sensed impedance at the third impedance sensor. Further, in one example, a gradient of particle vehicle separation within the fluid (120) may be compared to gradient values maintained in a look-up table to determine the PVS level between any of the first, second, and third impedance sensors.

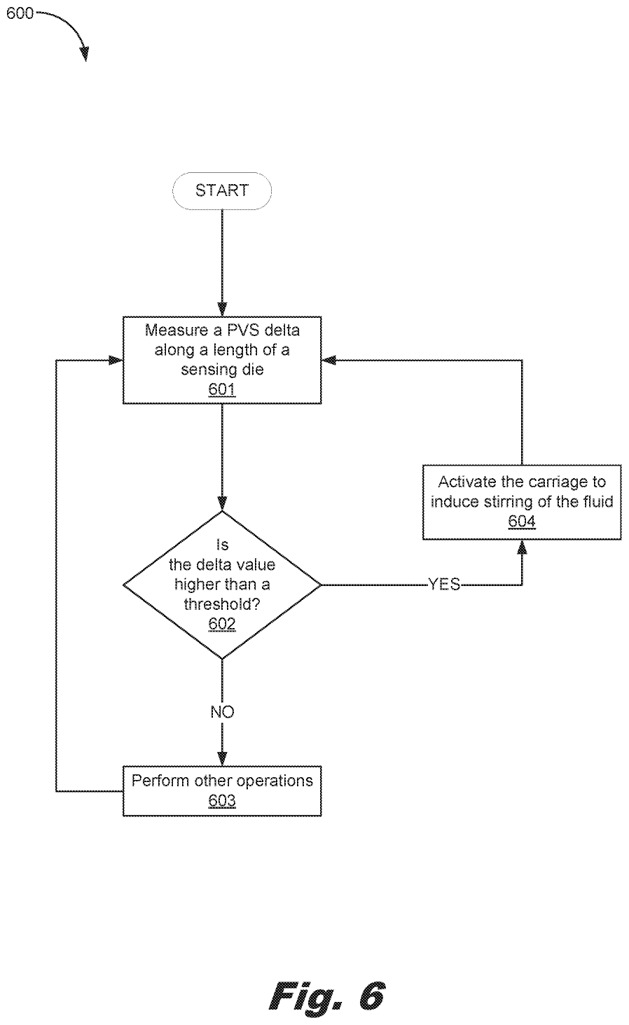

FIG. 6 is a flowchart depicting a method (600) of correcting particle vehicle separation within a fluid (120), according to an example of the principles described herein. The method (600) may include measuring (block 601) a number of PVS delta values among a number of impedance sensors (315) coupled to a sensing die (310) along a length of the sensing die (310). The impedance sensors (315) may each measure different PVS values due to the separation of the pigment from the fluid vehicle of the fluid (120) as the pigment settles in the fluid chamber (101) of the fluid reservoir (100).

The delta value measured among the impedance sensors (315) may be higher or lower than a threshold. Thus, the method (600) may include determining (block 602) if the delta value measured among the impedance sensors (315) is higher than a threshold where a delta value higher than the threshold indicates that PVS has occurred within the fluid (120) to the point where is may be corrected. Thus, in response to a determination that the delta value is higher than the threshold (block 602, determination YES), the carriage (130) may be activated (block 604) in order to induce the stirring of the fluid (120) within the fluid chamber (101). The method may then loop back to block 601 to allow for another measurement of the PIVS values and a determination of a PVS delta may take place in order to determine if another iteration of the stirring of the fluid at block 604 may be performed. In contrast, in response to a determination that the delta value is not higher than the threshold (block 602, determination NO) different operations may be performed such as, for example, a number of printing operations or other operations in which the fluid in a non-PVS state may be used because the fluid's (120) pigments are not separated from its fluid vehicle. The method may loop back to block 601 in order to allow for another measurement of the PIVS values and a determination of a PVS delta may take place in order to determine if the pigment within the fluid (120) has not settled and may be used in other operations.

The specification and figures describe a fluid reservoir. The fluid reservoir may include a fluid chamber to contain a fluid, and an impedance sensor exposed to a fluid within the fluid chamber. The impedance sensor senses an impedance at the impedance sensor, determines a particle vehicle separation level of the fluid within the fluid chamber based on the sensed impedance, and sends an activation signal to a moveable carriage to which the fluid reservoir is coupled to stir the fluid within the fluid reservoir based on the sensed impedance.

The preceding description has been presented to illustrate and describe examples of the principles described. This description is not intended to be exhaustive or to limit these principles to any precise form disclosed. Many modifications and variations are possible in light of the above teaching.

What is claimed is:

1. A fluid reservoir comprising:
a fluid chamber to contain a fluid; and
an impedance sensor exposed to a fluid within the fluid chamber to:
sense an impedance at the impedance sensor;
determine a particle vehicle separation level of the fluid within the fluid chamber based on the sensed impedance; and
send an activation signal to a moveable carriage to which the fluid reservoir is coupled to stir the fluid within the fluid reservoir based on the sensed impedance.

2. The fluid reservoir of claim 1, wherein:
the activation signal is sent in response to a determination that the sensed impedance indicates particle vehicle separation above a threshold; and
the activation signal is not sent in response to a determination that the sensed impedance indicates particle vehicle separation below the threshold.

3. The fluid reservoir of claim 1, wherein the particle vehicle separation level of the fluid is defined by an impedance value based on the sensed impedance, and wherein:
a relatively lower impedance corresponds to a higher particle concentration within the fluid; and
a relatively higher impedance corresponds to a lower particle concentration within the fluid.

4. The fluid reservoir of claim 1, comprising:
a sensing die extending through a level of fluid in the reservoir; and
a first impedance sensor and a second impedance sensor coupled to the sensing die at different portions of the sensing die to sense a degree of pigment separation in the fluid at different levels of the fluid.

5. The fluid reservoir of claim 4, comprising a controller to:
determine a sensed impedance at the first impedance sensor;
determine a sensed impedance at the second impedance sensor;
determine a particle vehicle separation level of a fluid within the fluid chamber based on the sensed impedance at the first impedance sensor and the sensed impedance at the second impedance sensor; and
send the activation signal to the moveable carriage to stir the fluid within the fluid chamber based on the particle vehicle separation level of the fluid.

6. The fluid reservoir of claim 5, comprising a third impedance sensor placed intermittent between the first impedance sensor and the second impedance sensor, wherein when any of the first, second, and third impedance sensors are not in contact with the fluid, a maximum impedance is sensed and disregarded.

7. The fluid reservoir of claim 1, comprising a fluid level sensor to provide a sensed level of fluid within the fluid reservoir.

8. A fluid dispensing system, comprising:
a moveable carriage to convey a fluid reservoir; and
a controller to activate the moveable carriage to move the fluid reservoir in a coordinate direction based on an impedance-sensed particle vehicle separation level of a fluid within the fluid reservoir.

9. The fluid dispensing system of claim 8, comprising
a sensing die extending through a level of fluid in the reservoir; and
a first electrode and a second electrode coupled to the sensing die at different portions of the sensing die to sense the particle vehicle separation level in the fluid at different levels of the fluid;
wherein the controller:
determines a sensed impedance at the first electrode;
determines a sensed impedance at the second electrode;
determines the particle vehicle separation level of the fluid within the fluid reservoir based on the sensed impedance at the first electrode and a sensed impedance at the second electrode; and
sends an activation signal to the moveable carriage to stir the fluid within the fluid reservoir based on the particle vehicle separation level of the fluid.

10. The fluid dispensing system of claim 8,
wherein the impedance sensed at the first and second electrodes corresponds to a dispersion level of a solid within a fluid vehicle of the fluid,
wherein the controller activates the carriage in response to a determination that the sensed impedance indicates a particle vehicle separation above a threshold, and
wherein the particle vehicle separation level of the fluid is defined by an impedance value based on the sensed impedance, and wherein:
a relatively lower impedance corresponds to a higher particle concentration within the fluid; and
a relatively higher impedance corresponds to a lower particle concentration within the fluid.

11. The fluid dispensing system of claim 10, comprising a third electrode placed intermittent between the first electrode and the second electrode, wherein when any of the first, second, and third electrodes are not in contact with the fluid, a maximum impedance is sensed and disregarded.

12. The fluid dispensing system of claim 9, wherein the first electrode, the second electrode, or combinations thereof measure a level of the fluid within the fluid reservoir.

13. A method of correcting particle vehicle separation within a fluid, comprising:
receiving a first sensed impedance value of the fluid from a first impedance sensor located at a first level within a fluid reservoir;
receiving a second sensed impedance value of the fluid from a second impedance sensor located at a second level within the fluid reservoir;
determining a particle vehicle separation level of the fluid based on the first sensed impedance at the first impedance sensor and the sensed impedance at the second impedance sensor; and
sending an activation signal to a moveable carriage to which the fluid reservoir is coupled to move the fluid reservoir in a coordinate direction to stir the fluid within the fluid reservoir based on the particle vehicle separation level of the fluid.

14. The method of claim 13, comprising:
receiving a third sensed impedance value of the fluid from a third impedance sensor; and
determining a particle vehicle separation level of the fluid based on the first sensed impedance at the first impedance sensor, the sensed impedance at the second impedance sensor, and the third sensed impedance at the third impedance sensor.

15. The method of claim 14, wherein the gradient of particle vehicle separation within the fluid is compared to gradient values maintained in a look-up table to determine the pigment separation between any of the first, second, and third impedance sensors.
